(19) United States
(12) Patent Application Publication
(10) Pub. No.: US 2019/0344844 A1
(43) Pub. Date: Nov. 14, 2019

(54) ELASTIC CRAWLER

(71) Applicant: BRIDGESTONE CORPORATION, Chuo-ku Tokyo (JP)

(72) Inventors: Takashi MIZUSAWA, Yokohama-shi, Kanagawa (JP); Shoko NAGAMOTO, Chuo-ku, Tokyo (JP)

(73) Assignee: BRIDGESTONE CORPORATION, Chuo-ku Tokyo (JP)

(21) Appl. No.: 16/476,090

(22) PCT Filed: Jan. 18, 2018
(86) PCT No.: PCT/JP2018/001419

§ 371 Date: Jul. 4, 2019

(30) Foreign Application Priority Data
Jan. 20, 2017 (JP) 2017-008925

(51) Int. Cl. B62D 55/24; B62D 55/26

(52) U.S. Cl. CPC B62D 55/244; B62D 55/26

(57) ABSTRACT

Provided is an elastic crawler that is easy to produce and has improved mud drainage, without requiring major revision of an existing elastic crawler. The elastic crawler includes a crawler body shaped as an endless belt and lugs (3) arranged at intervals in the peripheral direction on an outer peripheral surface (2a) of the crawler body (2). The lugs (3) each include a kick-in surface (3a) on the kick-in side towards the front in the crawler rotation direction, and the kick-in surface (3a) has a curved shape protruding towards the front in the crawler rotation direction.

### TECHNICAL FIELD

The present disclosure relates to an elastic crawler.

### BACKGROUND

Elastic crawlers are assumed to be used typically in rice paddies, swampy areas, snowy roads, or the like. Therefore, measures have been taken in elastic crawlers to suppress the adhesion of dirt, mud, snow, and the like and to improve the drainage performance with respect to these substances (“mud drainage”). In some known elastic crawlers in which such measures are taken, the position of the lugs relative to the crawler body has been improved. For example, see patent literature (PTL) 1.

### CITATION LIST

### Patent Literature

PTL 1: JP2008-213715A

### SUMMARY

### Technical Problem

A change in the position and shape of the lugs, however, leads to a change in the lug pattern. Such a change in the lug pattern may change the impression caused by the appearance of the elastic crawler. In particular, changing the position of the lugs relative to the crawler body not only changes the impression caused by the appearance but may also require major revision of the production method to accommodate significant design changes or the like.

It is an objective of the present disclosure to provide an elastic crawler that is easy to produce and has improved mud drainage, without requiring major revision of an existing elastic crawler.

### Solution to Problem

An elastic crawler according to the present disclosure includes a crawler body shaped as an endless belt and a plurality of lugs arranged at intervals in a crawler peripheral direction on an outer peripheral surface of the crawler body. The lugs each include a kick-in surface on a kick-in side towards a front in a crawler rotation direction, and the kick-in surface has a curved shape protruding towards the front in the crawler rotation direction.

The elastic crawler according to the present disclosure is easy to produce and has improved mud drainage, without requiring major revision of an existing elastic crawler.

In the elastic crawler according to the present disclosure, the lugs are preferably arranged to form a space continuous in the crawler peripheral direction at a crawler widthwise central portion of the elastic crawler.

In this case, dirt, mud, snow, or the like tends not to adhere, and the mud drainage is further improved, in particular in the crawler widthwise central portion of the elastic crawler.

The elastic crawler according to the present disclosure may further include projections arranged at intervals in the crawler peripheral direction on an inner peripheral surface of the crawler body, and the kick-in surface may have the curved shape at least from a crawler widthwise outer side of the lugs to a crawler widthwise edge of the projections.

In this case, the elastic crawler can be produced more easily.

### Advantageous Effect

The present disclosure can provide an elastic crawler that is easy to produce and has improved mud drainage, without requiring major revision of an existing elastic crawler.

### BRIEF DESCRIPTION OF THE DRAWINGS

In the accompanying drawings:

FIG. 1 is a plan view illustrating the outer peripheral surface of an elastic crawler according to a first embodiment of the present disclosure;

FIG. 2 is a plan view illustrating the inner peripheral surface of the elastic crawler of FIG. 1;

FIG. 3 is a cross-sectional view along line X-X of FIG. 1;

FIG. 4A is a cross-sectional view along line A-A of FIG. 1;

FIG. 4B is a cross-sectional view along line B-B of FIG. 1;

FIG. 4C is a cross-sectional view along line C-C of FIG. 1;

FIG. 4D is a main cross-sectional view illustrating a portion, corresponding to the A-A cross-section and B-B cross-section of FIG. 1, of a lug according to a known elastic crawler;

FIG. 5A is a chronological illustration of the kicking-out state of the lug according to the elastic crawler of FIG. 1;

FIG. 5B is a chronological illustration of the kicking-out state of the lug according to a known elastic crawler; and

FIG. 6 is a plan view illustrating the outer peripheral surface of an elastic crawler according to a second embodiment of the present disclosure.

### DETAILED DESCRIPTION

With reference to the drawings, elastic crawlers according to various embodiments of the present disclosure are described.

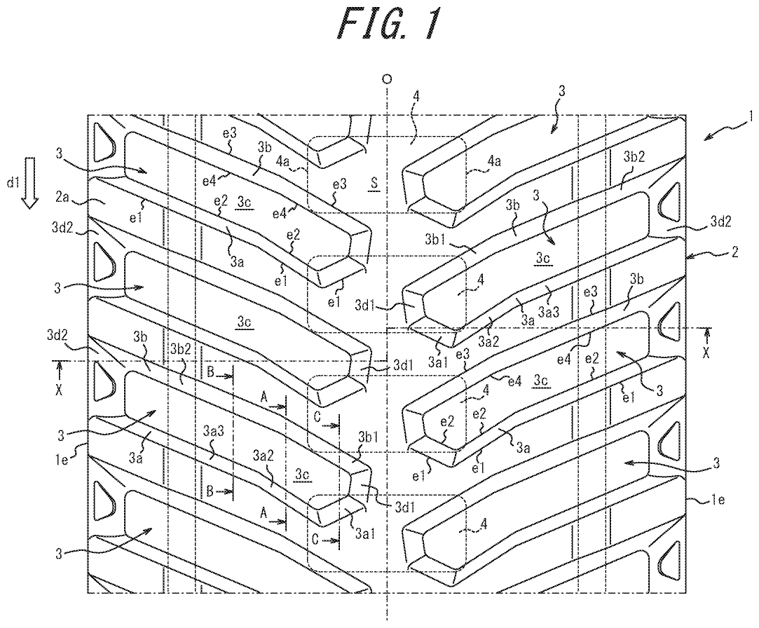

FIG. 1 illustrates the outer peripheral surface of an elastic crawler 1 according to a first embodiment of the present disclosure. The elastic crawler 1 is mainly configured by an elastic material. In the present embodiment, the elastic crawler 1 is mainly configured by rubber, for example. In the present embodiment, the elastic crawler 1 rotates in the direction of the hollow arrow d1 illustrated in FIG. 1 when the vehicle (not illustrated) is driven. The arrow d1 indicates the rotation direction of the elastic crawler 1.

The elastic crawler 1 includes a crawler body 2 shaped as an endless belt. The crawler body 2 is mainly configured by an elastic material. In the present embodiment, the crawler body 2 is mainly configured by rubber, for example. The “peripheral direction of the elastic crawler 1” in the present embodiment is the same as the “peripheral direction of the crawler body 2”. The “peripheral direction of the elastic crawler 1” is also simply referred to below as the “crawler peripheral direction”. The “width direction of the elastic crawler 1” in the present embodiment is the same as the “width direction of the crawler body 2”. The “width direction of the elastic crawler 1” is also simply referred to below as the “crawler width direction”.

The elastic crawler 1 includes a plurality of lugs 3. The lugs 3 are arranged on the outer peripheral surface 2a of the crawler body 2 (the outer peripheral surface of the elastic crawler 1) at intervals in the crawler peripheral direction. The lugs 3 are mainly configured by an elastic material. In the present embodiment, the lugs 3 are mainly configured by rubber, for example. In the present embodiment, the lugs 3 are adhered by vulcanization to the outer peripheral surface 2a of the crawler body 2. The lugs 3 can be formed integrally with the crawler body 2 using a mold. The method of disposing the lugs 3 on the crawler body 2 is not limited to adhesion or molding.

In the present embodiment, the lugs 3 are arranged to form a space S continuous in the crawler peripheral direction at the crawler widthwise central portion of the elastic crawler 1. In the present embodiment, the lugs 3 are arranged with a gap therebetween in the crawler width direction, so as to sandwich a center line O passing through the crawler widthwise center of the elastic crawler 1. Consequently, as illustrated in FIG. 1, the lugs 3 of the present embodiment form the space S that is continuous in the crawler peripheral direction at the crawler widthwise central portion of the elastic crawler 1. In other words, a see-through portion continuous in the crawler peripheral direction is formed in the present embodiment by the space S being continuous in the crawler peripheral direction. The “see-through portion” refers to a space that is continuous in the crawler peripheral direction without being blocked by lugs 3. Furthermore, the lugs 3 in the present embodiment are staggered in the crawler peripheral direction. In the present embodiment, the space S is a see-through portion that zigzags (winds) continuously in the crawler peripheral direction.

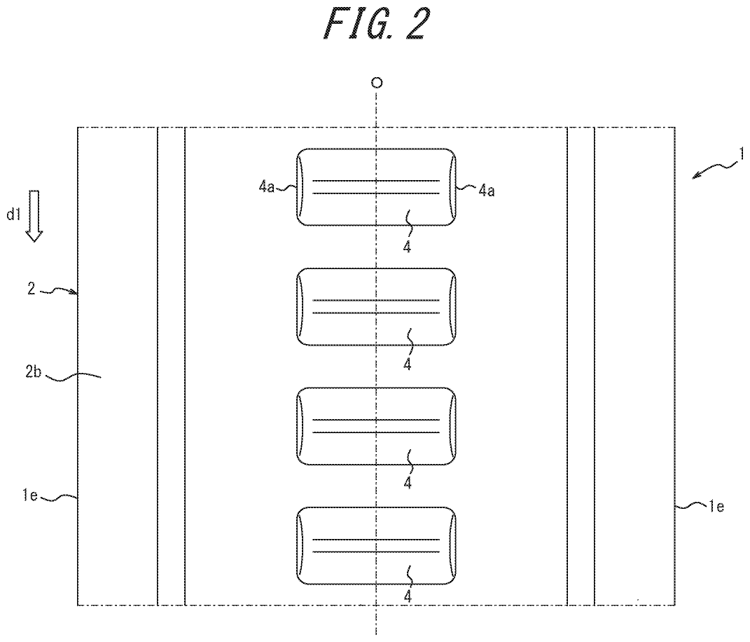

As illustrated in FIG. 2, the elastic crawler 1 in the present embodiment further includes projections 4 arranged at intervals in the crawler peripheral direction on the inner peripheral surface 2b of the crawler body 2 (the inner peripheral surface of the elastic crawler 1). As described above, the projections 4 are mainly configured by an elastic material. In the present embodiment, the projections 4 are mainly configured by rubber, for example. In the present embodiment, the projections 4 are adhered by vulcanization to the inner peripheral surface 2b of the crawler body 2. The projections 4 can also be formed integrally with the crawler body 2 using a mold. The method of disposing the projections 4 on the crawler body 2 is not limited to adhesion or molding.

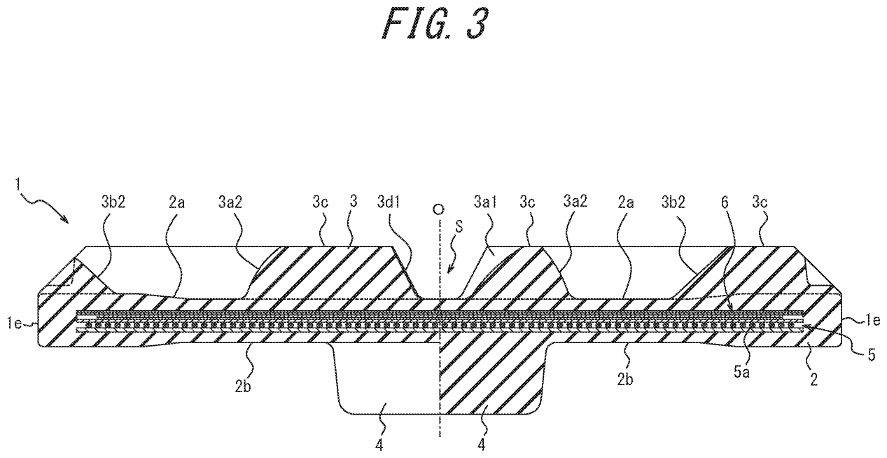

As illustrated in the cross-sectional view of FIG. 3, the elastic crawler 1 in the present embodiment is a “core-less” elastic crawler. In other words, as illustrated in FIG. 3, the elastic crawler 1 in the present embodiment does not have core bars inside the crawler body 2.

A main cord layer is labeled 5 in FIG. 3. The main cord layer 5 includes a plurality of metal cords (such as steel cords) 5a embedded in the crawler body 2 and extending in the peripheral direction of the crawler body 2. In the present embodiment, the main cord layer 5 is a 0° ply in which the plurality of metal cords 5a are wound in parallel in the peripheral direction. The main cord layer 5 includes one layer in the present embodiment but may instead be a plurality of layers at intervals in the width direction. The metal cords 5a are configured by twisting a plurality of steel filaments in the present embodiment but may also be configured entirely by single steel filaments.

A reinforcing cord layer is labeled 6. The reinforcing cord layer 6 includes a plurality of non-illustrated reinforcing cords (omitted from the drawings) that, in the plan view of FIG. 1 or FIG. 2 (as viewed in the thickness direction of the elastic crawler 1), are embedded in the crawler body 2 at an inclination relative to the peripheral direction. In the present embodiment, the reinforcing cord layer 6 is a bias ply in which the plurality of reinforcing cords are inclined relative to the peripheral direction. As illustrated in FIG. 3, the reinforcing cord layer 6 in the present embodiment is disposed towards the outer peripheral side of the crawler body 2 from the main cord layer 5. The reinforcing cord layer 6 is not limited to this configuration, however, and can be disposed towards the inner peripheral side of the crawler body 2 from the main cord layer 5, for example. The reinforcing cord layer 6 can also be disposed on both the inner and outer peripheral sides of the crawler body 2 so as to sandwich the main cord layer 5. It suffices for the reinforcing cord layer 6 to include at least one layer. The reinforcing cord layer 6 can, however, be omitted from the elastic crawler 1.

As illustrated in FIG. 1, the lugs 3 in the present embodiment are shaped to be inclined relative to the crawler peripheral direction and the crawler width direction in the plan view of FIG. 1. Specifically, the lugs 3 are shaped so that, in the plan view of FIG. 1, the central portion in the crawler width direction is disposed farther towards one side in the crawler peripheral direction than the outer portion in the crawler width direction. In the present embodiment, the lugs 3 are shaped so that, in the plan view of FIG. 1, the central portion in the crawler width direction is disposed farther forward in the rotation direction of the elastic crawler 1 (the direction of the arrow d1) than the outer portion in the crawler width direction.

Furthermore, in the plan view of FIG. 1, the lugs 3 in the present embodiment include a kick-in surface 3a on the kick-in side in the crawler peripheral direction. In the present disclosure, the “kick-in side in the crawler peripheral direction” of the lugs 3 refers to the side, between the two crawler peripheral direction sides of the lugs 3, that contacts the ground first when the elastic crawler 1 is rotating relative to the vehicle. In other words, the “kick-in side in the crawler peripheral direction” of the lugs 3 refers to the front in the rotation direction of the elastic crawler 1.

In the present embodiment, the kick-in surface 3a is formed by a first kick-in surface 3a1, a second kick-in surface 3a2, and a third kick-in surface 3a3 in the plan view of FIG. 1.

In the present embodiment, the first kick-in surface 3a1 is disposed towards the crawler widthwise center of the elastic crawler 1. In the present embodiment, the first kick-in surface 3a1 is inclined, in the plan view of FIG. 1, towards the rear in the rotation direction of the elastic crawler 1 as the first kick-in surface 3a1 approaches the crawler widthwise center (center line O) of the elastic crawler 1. In the present embodiment, the first kick-in surface 3a1 is disposed at a position that, in the plan view of FIG. 1, partially overlaps the projection 4 (indicated by the dashed line in FIG. 1) on the inner peripheral surface 2b side of the crawler body 2.

In the present embodiment, the second kick-in surface 3a2 is connected to the first kick-in surface 3a1 in the crawler width direction. In the present embodiment, the second kick-in surface 3a2 is inclined, in the plan view of FIG. 1, towards the rear in the rotation direction of the elastic crawler 1 as the second kick-in surface 3a2 approaches the crawler widthwise outer side.

In the present embodiment, the third kick-in surface 3a3 is disposed towards the crawler widthwise outer side of the elastic crawler 1. In the present embodiment, the third kick-in surface 3a3 is connected to the second kick-in surface 3a2 in the crawler width direction. In the present embodiment, the third kick-in surface 3a3 is inclined, in the plan view of FIG. 1, towards the rear in the rotation direction of the elastic crawler 1 as the third kick-in surface 3a3 approaches the crawler widthwise outer side of the elastic crawler 1. In the present embodiment, the third kick-in surface 3a3 has a larger angle, on the acute side, relative to the center line O than does the second kick-in surface 3a2 in the plan view of FIG. 1. In other words, in the present embodiment, the third kick-in surface 3a3 is disposed in a state closer to being parallel to the crawler width direction axis than the second kick-in surface 3a2 is in the plan view of FIG. 1.

In the plan view of FIG. 1, the lugs 3 in the present embodiment include a kick-out surface 3b on the kick-out side in the crawler peripheral direction. In the present disclosure, the “kick-out side in the crawler peripheral direction” of the lugs 3 refers to the side, between the two crawler peripheral direction sides of the lugs 3, that contacts the ground last when the elastic crawler 1 is rotating relative to the vehicle. In other words, the “kick-out side in the crawler peripheral direction” of the lugs 3 refers to the rear in the rotation direction of the elastic crawler 1, i.e. the opposite side from the “kick-in side”.

In the present embodiment, the kick-out surface 3b is formed by a first kick-out surface 3b1 and a second kick-out surface 3b2 in the plan view of FIG. 1.

In the present embodiment, the first kick-out surface 3b1 is disposed towards the crawler widthwise center of the elastic crawler 1. In the present embodiment, the first kick-out surface 3b1 is inclined, in the plan view of FIG. 1, towards the rear in the rotation direction of the elastic crawler 1 as the first kick-out surface 3b1 approaches the crawler widthwise outer side. In the present embodiment, the first kick-out surface 3b1 is disposed at a position that, in the plan view of FIG. 1, partially overlaps the projection 4 (indicated by the dashed line in FIG. 1) on the inner peripheral surface 2b side of the crawler body 2.

In the present embodiment, the second kick-out surface 3b2 is connected to the first kick-out surface 3b1 in the crawler width direction. In the present embodiment, the second kick-out surface 3b2 is inclined, in the plan view of FIG. 1, towards the rear in the rotation direction of the elastic crawler 1 as the second kick-out surface 3b2 approaches the crawler widthwise outer side. In the present embodiment, the second kick-out surface 3b2 has a larger inclination angle, on the acute side, relative to the center line O than does the first kick-out surface 3b1 in the plan view of FIG. 1. In other words, in the present embodiment, the second kick-out surface 3b2 is disposed in a state closer to being parallel to the crawler widthwise line of the elastic crawler 1 than the first kick-out surface 3b1 is in the plan view of FIG. 1.

In the present embodiment, the lugs 3 include a crawler widthwise center-side end surface 3d1 towards the crawler widthwise center of the elastic crawler 1 in the plan view of FIG. 1. The crawler widthwise center-side end surface 3d1 of the lug 3 is connected, in the crawler peripheral direction, to the crawler widthwise center side of the kick-in surface 3a of the lug 3 and to the crawler widthwise center side of the kick-out surface 3b of the lug 3. In the present embodiment, the crawler widthwise center-side end surface 3d1 of the lug 3 is connected to the first kick-in surface 3a1 of the kick-in surface 3a of the lug 3 and the first kick-out surface 3b1 of the kick-out surface 3b of the lug 3. Along with the first kick-in surface 3a1 and the first kick-out surface 3b1 of the lug 3, the crawler widthwise center-side end surface 3d1 of the lug 3 in the present embodiment forms a portion of the outline of the space S in the plan view of FIG. 1.

In the present embodiment, the lugs 3 include a crawler widthwise outer end surface 3d2 towards the crawler widthwise outer side of the elastic crawler 1 in the plan view of FIG. 1. The crawler widthwise outer end surface 3d2 of the lug 3 is connected, in the crawler peripheral direction, to the crawler widthwise outer side of the kick-in surface 3a of the lug 3 and to the crawler widthwise outer side of the kick-out surface 3b of the lug 3. In the present embodiment, the crawler widthwise outer end surface 3d2 of the lug 3 is connected to the third kick-in surface 3a3 of the kick-in surface 3a of the lug 3 and the second kick-out surface 3b2 of the kick-out surface 3b of the lug 3. In the present embodiment, the crawler widthwise outer end surface 3d2 of the lug 3 is disposed at a position adjacent to a crawler widthwise outer edge 1e of the elastic crawler 1 (crawler body 2) in the plan view of FIG. 1.

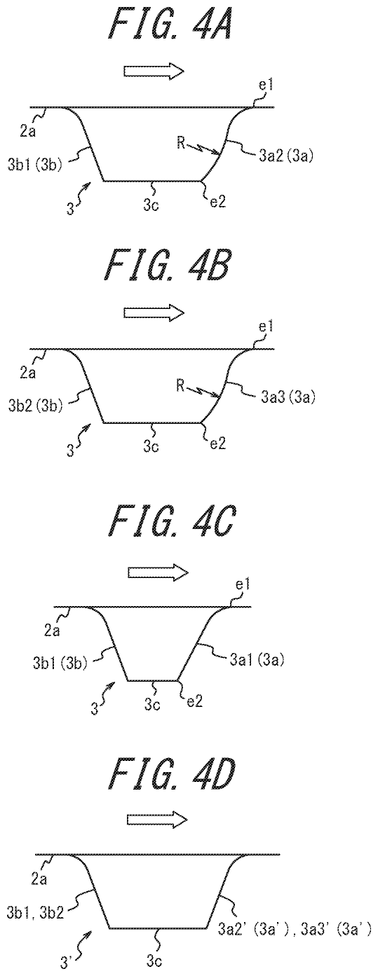

In the present embodiment, the kick-out surface 3b is connected to the kick-in surface 3a, in the plan view of FIG. 1, via a tread 3c. As illustrated in FIGS. 4A to 4C, the tread 3c of the lug 3 in the present embodiment is disposed at the position farthest away from the outer peripheral surface 2a of the crawler body 2. As illustrated in FIGS. 4A to 4C, the tread 3c of the lug 3 in the present embodiment is configured to be planar.

Furthermore, the kick-in surface 3a of the lug 3 in the present embodiment has a curved shape protruding towards the front in the crawler rotation direction. In the present embodiment, as illustrated in FIGS. 4A and 4B, the second kick-in surface 3a2 and the third kick-in surface 3a3 of the lug 3 have a curved shape, protruding towards the front in the crawler rotation direction relative to the lug 3, in a cross-sectional view from the crawler width direction (crawler widthwise cross-sectional view). In this example, the second kick-in surface 3a2 and the third kick-in surface 3a3 of the lug 3 have a curved shape, protruding towards the front in the crawler rotation direction relative to the lug 3, formed at a radius of curvature R. In other words, in the present embodiment, the center of the radius of curvature R of the second kick-in surface 3a2 and the third kick-in surface 3a3 of the lug 3 is positioned towards the center in the crawler peripheral length (thickness) direction of the lug 3 in the plan view of FIG. 1. Consequently, in the present embodiment, the second kick-in surface 3a2 and the third kick-in surface 3a3 of the lug 3 have a curved shape protruding towards the front in the crawler rotation direction.

In the present embodiment, the edge that forms the outline, on the kick-in side, of the kick-in surface 3a of the lug 3 against the outer peripheral surface 2a of the crawler body 2 in the plan view of FIG. 1 is labeled e1 (“kick-in side outline edge e1 of the kick-in surface 3a of the lug 3”). Furthermore, in the present embodiment, the edge that forms the outline, on the kick-out side, of the kick-in surface 3a of the lug 3 in the plan view of FIG. 1 is labeled e2 (“kick-out side outline edge e2 of the kick-in surface 3a of the lug 3”). In the present embodiment, the kick-out side outline edge e2 of the kick-in surface 3a of the lug 3 is also the edge that forms the outline, on the kick-in side, of the tread 3c of the lug 3 in the plan view of FIG. 1.

In the present embodiment, the edge that forms the outline, on the kick-out side, of the kick-out surface 3b of the lug 3 against the outer peripheral surface 2a of the crawler body 2 in the plan view of FIG. 1 is labeled e3 (“kick-out side outline edge e3 of the kick-out surface 3b of the lug 3”). Furthermore, in the present embodiment, the edge that forms the outline, on the kick-in side, of the kick-out surface 3b of the lug 3 in the plan view of FIG. 1 is labeled e4 (“kick-in side outline edge e4 of the kick-out surface 3b of the lug 3”). In the present embodiment, the kick-in side outline edge e4 of the kick-out surface 3b of the lug 3 is also the edge that forms the outline, on the kick-out side, of the tread 3c of the lug 3 in the plan view of FIG. 1.

As illustrated in FIG. 1, the kick-in side outline edge e1 of the kick-in surface 3a of the lug 3 is farther towards the front in the rotation direction of the elastic crawler 1 than the kick-out side outline edge e2 of the kick-in surface 3a of the lug 3 in a crawler widthwise cross-sectional view. In other words, as illustrated in FIGS. 4A to 4C, the kick-in surface 3a of the lug 3 in the present embodiment forms an inclined surface inclined relative to the thickness direction of the elastic crawler 1 from the outer peripheral surface 2a of the crawler body 2 to the tread 3c of the lug 3 in a crawler widthwise cross-sectional view. In particular, as illustrated in FIGS. 4A and 4B, the second kick-in surface 3a2 and the third kick-in surface 3a3 of the lug 3 in the present embodiment have a curved shape protruding outward with a radius of curvature R (when viewed from the center in the crawler peripheral length (thickness) direction of the lug 3 in the plan view of FIG. 1). In the present embodiment, the radius of curvature R passes through the kick-out side outline edge e2 of the kick-in surface 3a of the lug 3 in a crawler widthwise cross-sectional view, as illustrated in FIGS. 4A and 4B. Consequently, in the present embodiment, the second kick-in surface 3a2 and the third kick-in surface 3a3 of the lug 3 are formed by an inclined, curved surface protruding with the radius of curvature R towards the front in the crawler rotation direction from the tread 3c of the lug 3 in a crawler widthwise cross-sectional view.

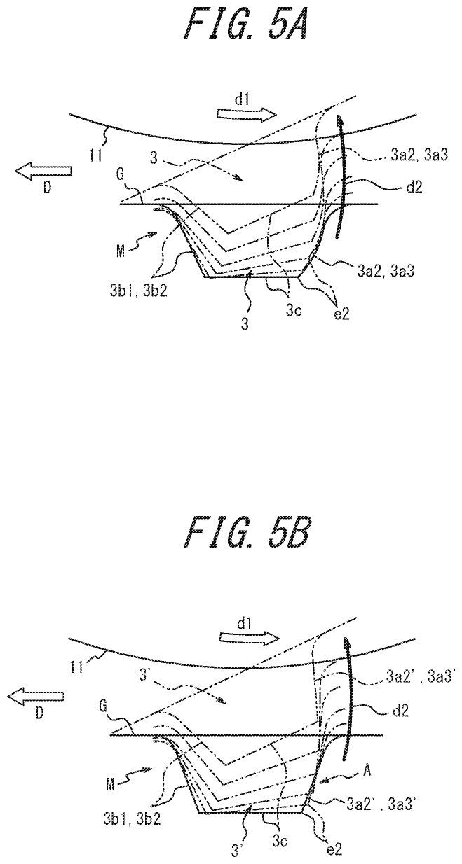

FIG. 5A is a chronological illustration of the kicking-out state of the lug 3 according to the elastic crawler 1 of FIG. 1. Portions that are substantially the same as in FIGS. 1 to 4C are labeled with the same reference signs, and a description thereof is omitted.

In FIG. 5A, a rotating wheel such as a drive wheel, an idling wheel, a track roller, or the like attached to the vehicle (not illustrated) is labeled 11. The arrow d1 indicates the rotation direction of the rotating wheel 11, i.e. the rotation direction of the elastic crawler 1. The travel direction of the vehicle is labeled D. Dirt, mud, snow, or the like (“mud or the like”) is labeled M, and the surface thereof (“road surface”) is labeled G.

When the rotating wheel 11 of the vehicle rotates in the direction indicated by the arrow d1, the elastic crawler 1 also rotates in the direction of the arrow d1. At this time, from a state of being sunk in the mud or the like M as illustrated by the solid line in FIG. 5A, the lugs 3 of the elastic crawler 1 are kicked out from the road surface G in the direction of the arrow d2 while following the trajectory indicated by the dashed double-dotted lines. In this way, the elastic crawler 1 can move the vehicle in the direction indicated by the arrow D.

As illustrated in FIGS. 4A and 4B, the second kick-in surface 3a2 and the third kick-in surface 3a3 of the lug 3 in the elastic crawler 1 according to the present embodiment are formed as curved shapes protruding with the radius of curvature R in a crawler widthwise cross-sectional view. Therefore, mud or the like M easily separates along the second kick-in surface 3a2 and the third kick-in surface 3a3 of the lug 3 in the elastic crawler 1 according to the present embodiment. Furthermore, as illustrated by the trajectory in FIG. 5A, the kick-out side outline edge e2 of the kick-in surface 3a of the lug 3 in the elastic crawler 1 according to the present embodiment hardly scrapes out the mud or the like M. Moreover, in the present embodiment, the second kick-in surface 3a2 and the third kick-in surface 3a3 of the lug 3 simply have a curved shape protruding towards the front in the crawler rotation direction. Accordingly, the elastic crawler 1 according to the present embodiment is easy to produce and has improved mud drainage, without requiring major revision of an existing elastic crawler.

FIG. 4D illustrates a portion, corresponding to the A-A cross-section and B-B cross-section of FIG. 1, of a lug 3′ according to a known elastic crawler. FIG. 5B is a chronological illustration of the kicking-out state of the lug 3′ according to the known elastic crawler of FIG. 4D. Portions that are substantially the same as in FIGS. 1 to 4C and FIG. 5A are labeled with the same reference signs, and a description thereof is omitted.

As illustrated in FIG. 4D, in a known elastic crawler, the lug 3′ includes a second kick-in surface 3a2′ and a third kick-in surface 3a3′, corresponding to the second kick-in surface 3a2 and the third kick-in surface 3a3 of the lug 3, on a kick-in surface 3a′. The second kick-in surface 3a2′ and the third kick-in surface 3a3′ of the kick-in surface 3a′ in the known lug 3′ are each formed to be flat. In other words, the kick-in surface 3a′ of the known lug 3′ does not have a curved shape protruding towards the front in the crawler rotation direction. Therefore, mud or the like M does not easily separate along the second kick-in surface 3a2′ and the third kick-in surface 3a3′ of the lug 3′ in the known elastic crawler. Furthermore, as indicated by the label A in FIG. 5B, the kick-out side outline edge e2 of the kick-in surface 3a′ of the lug 3′ in the known elastic crawler scrapes out the mud or the like M. Accordingly, a known elastic crawler still has room for improvement in terms of mud drainage.

In the elastic crawler 1 according to the present embodiment, the lugs 3 are arranged to form a space S at the crawler widthwise central portion of the elastic crawler 1 in the plan view of FIG. 1. In this case, mud or the like M separates easily and is hardly scraped out in the space S. The mud or the like M therefore tends not to adhere, and the mud drainage is further improved, in particular in the crawler widthwise central portion of the elastic crawler 1.

The elastic crawler 1 in the present embodiment further includes the projections 4 arranged at intervals in the crawler peripheral direction on the inner peripheral surface 2b of the crawler body 2. The projections 4 provided on the inner peripheral surface 2b of the crawler body 2 are arranged at positions overlapping, in the plan view of FIG. 1, with the space S provided on the outer peripheral surface 2a of the crawler body 2. In other words, forming the kick-in surface 3a of the lug 3 not to be a curved shape at the position of the projection 4 in the plan view of FIG. 1 increases the size of the space S at the crawler widthwise central portion, which is advantageous for mud drainage.

Therefore, in the present embodiment, the kick-in surface 3a of the lugs 3 has a curved shape, protruding towards the front in the crawler rotation direction, at least from the crawler widthwise outer side of the lug 3 to the crawler widthwise position of the lug 3 corresponding to a crawler widthwise edge 4a of the projection 4. In the present embodiment, as illustrated in FIGS. 4A and 4B, the second kick-in surface 3a2 and the third kick-in surface 3a3 of the lug 3 have a curved shape protruding towards the front in the crawler rotation direction. In other words, in the present embodiment, the kick-in surface 3a of the lug 3 has a curved shape, protruding towards the front in the crawler rotation direction, in the plan view of FIG. 1 at least from the crawler widthwise outer edge 1e of the elastic crawler 1 to the crawler widthwise position corresponding to the crawler widthwise edge 4a of the projection 4 adjacent to the crawler widthwise outer edge 1e.

On the other hand, the first kick-in surface 3a1 of the lug 3 in the present embodiment does not have a curved shape protruding towards the front in the crawler rotation direction, as illustrated in FIG. 4C. In other words, at least the first kick-in surface 3a1 of the kick-in surface 3a of the lug 3 in the present embodiment retains the shape of the existing lug 3′ in the plan view of FIG. 1. The elastic crawler 1 with improved mud drainage can more easily be produced in this case by retaining the shape of the existing lug 3′.

In this way, the present embodiment can provide an elastic crawler that is easy to produce and has improved mud drainage, without requiring major revision of an existing elastic crawler. The kick-in surface 3a of the lug 3 in the present embodiment has a curved shape protruding towards the front in the crawler rotation direction, and the protruding curved shape is configured to have a constant radius of curvature R along the crawler width direction. As a modification to the present embodiment, however, the radius of curvature R can also change as appropriate along the crawler width direction.

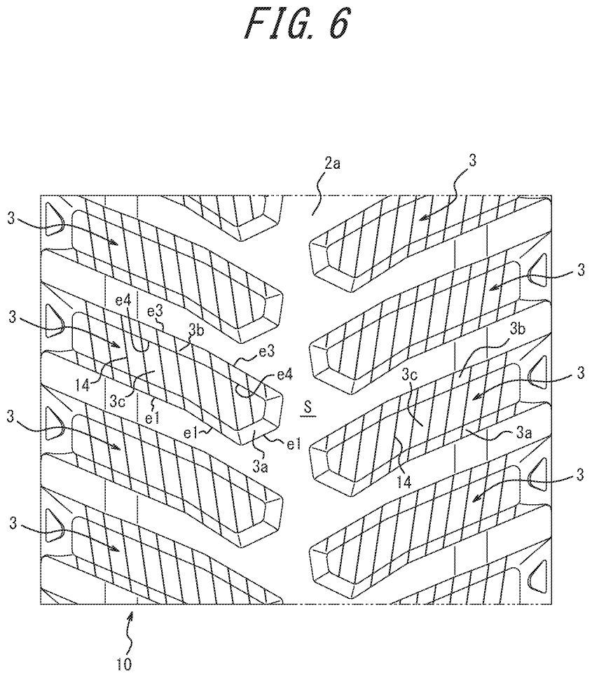

Additionally, FIG. 6 illustrates the outer peripheral surface of an elastic crawler 10 according to a second embodiment of the present disclosure. Portions that are substantially the same as the elastic crawler 1 according to the first embodiment are labeled with the same reference signs below, and a description thereof is omitted.

As illustrated in FIG. 6, a plurality of rows of minute protrusions (vent ridges) 14 are formed in the present embodiment on the kick-in surface 3a and the kick-out surface 3b of the lug 3. The minute protrusions 14 extend in a direction intersecting the crawler width direction when viewed from the crawler peripheral direction and are side-by-side in the crawler width direction. The minute protrusions 14 formed on the kick-in surface 3a and the kick-out surface 3b of the lug 3 in the present embodiment are also formed in rows on the tread 3c of the lug 3 to be side-by-side in the crawler width direction and continuous with the kick-in surface 3a and the kick-out surface 3b. Accordingly, in the present embodiment, a plurality of rows of ridge-shaped minute protrusions 14 extending continuously in the crawler peripheral direction on the kick-in surface 3a, the kick-out surface 3b, and the tread 3c of the lugs 3 are arranged at substantially equal intervals in the crawler width direction in the plan view of FIG. 6. The minute protrusions 14 in the present embodiment project outward from the surface of the lug 3.

In the present embodiment, the minute protrusions 14 formed on the kick-in surface 3a and the kick-out surface 3b of the lugs 3 need not be formed from the outer peripheral surface 2a of the crawler body 2, i.e. the lowest portion of the lug 3, to the tread 3c, i.e. the highest portion. In other words, the minute protrusions 14 in the present embodiment need not be formed over the entire range, in the height direction, of the kick-in surface 3a and the kick-out surface 3b.

It suffices for at least a component of the minute protrusions 14 to extend in the height direction of the kick-in surface 3a and the kick-out surface 3b as viewed in the crawler peripheral direction. In the present embodiment, the minute protrusions 14 are formed up to the kick-in side outline edge e1 of the kick-in surface 3a of the lug 3 (the kick-out side outline edge e3 of the kick-out surface 3b of the lug 3). The minute protrusions 14 need not be formed up to the kick-in side outline edge e1 of the kick-in surface 3a of the lug 3 (the kick-out side outline edge e3 of the kick-out surface 3b of the lug 3). The minute protrusions 14 may be formed without being continuous across the kick-in surface 3a, the kick-out surface 3b, and the tread 3c of the lug 3. The minute protrusions 14 may, for example, be formed only on the kick-in surface 3a, only on the kick-in surface 3a and the tread 3c, only on the kick-out surface 3b, or only on the kick-out surface 3b and the tread 3c.

At the time of vulcanization to form the elastic crawler 10 having the lugs 3 on which the minute protrusions 14 are formed, the minute protrusions 14 can be formed in the present embodiment by recesses provided in the elastic crawler mold in correspondence with the minute protrusions 14. When the minute protrusions 14 are formed by recesses provided in the mold, the recesses are preferably configured to communicate with an exhaust passage that opens to the outside of the mold. This configuration allows the recesses for forming the minute protrusions 14 to function as vents to discharge air from inside the elastic crawler mold to the outside of the mold at the time of vulcanization molding using the elastic crawler mold. Accordingly, to increase this effect of the air release, the minute protrusions 14 are preferably also formed on the tread 3c of the lug 3 and more preferably formed to be continuous from the kick-in surface 3a and/or the kick-out surface 3b to the tread 3c, as in the present embodiment.

In the present embodiment, the minute protrusions 14 preferably have a width of 0.5 mm to 3 mm, more preferably 0.7 mm to 2 mm. The minute protrusions 14 preferably have a height of 0.5 mm to 3 mm, more preferably 0.7 mm to 1 mm. Excessively narrow minute protrusions 14 risk a reduction in the effect of air release. Conversely, excessively wide minute protrusions 14 may become filled with rubber too early and stop achieving the function of air release. Excessively high minute protrusions 14 may, for example, catch in the mold during crawler production and cause damage. Conversely, excessively low minute protrusions 14 might not achieve a sufficient effect.

The minute protrusions 14 are preferably, but not necessarily, formed along the crawler peripheral direction. For example, the minute protrusions 14 may be inclined at a predetermined angle (for example, in a range of approximately ±20°) relative to the crawler peripheral direction in the plan view of FIG. 6. In this case, the minute protrusions 14 are inclined relative to the crawler width direction without becoming parallel to the crawler width direction. This is because minute protrusions 14 parallel to the crawler width direction might prevent removal from the mold at the time of vulcanization molding. The distance between rows of the minute protrusions 14 is preferably 10 mm to 20 mm, more preferably 10 mm to 15 mm, in the present embodiment. Processing might become difficult if the distance between rows of the minute protrusions 14 is too short. Conversely, the effect of air release might be reduced if the distance between rows of the minute protrusions 14 is too long.

The kick-in surface 3a and the kick-out surface 3b of the lugs 3 in the present embodiment are not limited to being an inclined surface formed by a single flat surface at a single inclination angle relative to the height direction of the lug 3 and may instead be a multi-step inclined surface formed by a plurality of flat surfaces or an inclined surface formed by an uneven curved surface. In the present embodiment, the kick-in surface 3a and the kick-out surface 3b of the lugs 3 may also be a two-step inclined surface that includes a convex surface, for example.

Only some of the embodiments of the present disclosure have been described, and a variety of changes may be made within the scope of the patent claims. For example, in the above embodiments, the first kick-in surface 3a1 of the lugs 3 does not have a curved shape protruding towards the rear in the crawler rotation direction. The first kick-in surface 3a1 may, however, have a curved shape protruding towards the rear in the crawler rotation direction like the second kick-in surface 3a2 and the third kick-in surface 3a3.

In the above embodiments, the lugs 3 can form the space S at least at one position in the width direction of the elastic crawler 1. In this case, the lugs can be disposed at three or more positions at intervals in the crawler width direction of the elastic crawler 1 in the plan view of FIG. 1 or FIG. 6, for example. Alternatively, the lugs can be configured not to form the space S at the widthwise center of the elastic crawler. In this case, the lugs may each be a single lug extending in the width direction of the elastic crawler 1 in the plan view of FIG. 1 or FIG. 6. The shape of the lugs 3 in the plan view of FIG. 1 or FIG. 6 can be changed appropriately as long as the kick-in surface 3a of the lugs 3 can be guaranteed. Yet another embodiment of the present disclosure includes an elastic crawler with core bars. In the case of an elastic crawler with core bars, the projections 4 according to the above embodiments can be replaced by the projections of the core bars, for example. The configurations of the above embodiments can be interchanged or combined as appropriate.

### REFERENCE SIGNS LIST

1 Elastic crawler (first embodiment)
2 Crawler body
2a Outer peripheral surface
2b Inner peripheral surface
3 Lug
3a Kick-in surface
3a1 First kick-in surface
3a2 Second kick-in surface
3a3 Third kick-in surface
3b Kick-out surface
3b1 First kick-out surface
3b2 Second kick-out surface
3c Tread
3d1 Crawler widthwise center-side end surface of lug
3d2 Crawler widthwise outer end surface of lug
4 Projection
4a Crawler widthwise edge of projection
10 Elastic crawler (second embodiment)
14 Minute protrusion
d1 Rotation direction of elastic crawler
e1 Kick-in side outline edge of kick-in surface of lug
e2 Kick-out side outline edge of kick-in surface of lug
e3 Kick-out side outline edge of kick-out surface of lug
e4 Kick-in side outline edge of kick-out surface of lug
S Space

1. An elastic crawler comprising a crawler body shaped as an endless belt and a plurality of lugs arranged at intervals in a crawler peripheral direction on an outer peripheral surface of the crawler body;
wherein the lugs each include a kick-in surface on a kick-in side towards a front in a crawler rotation direction, and the kick-in surface has a curved shape protruding towards the front in the crawler rotation direction.

2. The elastic crawler of claim 1, wherein the lugs are arranged to form a space continuous in the crawler peripheral direction at a crawler widthwise central portion of the elastic crawler.

3. The elastic crawler of claim 2, further comprising:
projections arranged at intervals in the crawler peripheral direction on an inner peripheral surface of the crawler body;
wherein the kick-in surface has the curved shape at least from a crawler widthwise outer side of the lugs to a crawler widthwise edge of the projections.
